(19) United States
(12) Patent Application Publication
(10) Pub. No.: US 2009/0081961 A1
(43) Pub. Date: Mar. 26, 2009

(54) METHOD AND SYSTEM FOR INJECTION LOCKING AN OSCILLATOR VIA FREQUENCY MULTIPLICATION OF A MULTIPHASE SIGNAL

(76) Inventor: Ahmadreza Rofougaran, Newport Coast, CA (US)

Correspondence Address: MCANDREWS HELD & MALLOY, LTD, 500 WEST MADISON STREET, SUITE 3400, CHICAGO, IL, 60661, US

(21) Appl. No.: 11/860,174

(22) Filed: Sep. 24, 2007

(51) Int. Cl. H04B 1/40

(52) U.S. Cl. 455/76

(57) ABSTRACT

Aspects of a method and system for injection locking an oscillator via frequency multiplication of a multi-phase signal are provided. A plurality of signals, each of which may be a phase shifted version of a reference signal, may be generated and utilized to generate an output signal. The output signal may be utilized to control a frequency of an oscillator. The frequency of the output signal may be a multiple of the reference frequency, and may be equal to the number of said first signals comprising said plurality. The frequency of the reference signal may be determined based on the number of said first signals comprising said plurality and on a desired frequency of the output signal. The number of signals comprising the plurality of first signals may be determined based on a frequency of said reference signal and on a desired frequency of said output signal.

### CROSS-REFERENCE TO RELATED APPLICATIONS/INCORPORATION BY REFERENCE

Not applicable

### FIELD OF THE INVENTION

Certain embodiments of the invention relate to signal processing. More specifically, certain embodiments of the invention relate to a method and system for injection locking an oscillator via frequency multiplication of a multi-phase signal.

### BACKGROUND OF THE INVENTION

As wireless communications continue to evolve and become increasingly relied upon for the conveyance of data, new challenges continue to face wireless system designers. In this regard, the increasing number of wireless technologies and wireless devices has led to increasing congestion in many frequency bands. Accordingly, efforts exist to utilize less congested frequency bands. For example, in 2001, the Federal Communications Commission (FCC) designated a large contiguous block of 7 GHz bandwidth for communications in the 57 GHz to 64 GHz spectrum. This frequency band was designated for use on an unlicensed basis, that is, the spectrum is accessible to anyone, subject to certain basic, technical restrictions such as maximum transmission power and certain coexistence mechanisms. The communications taking place in this band are often referred to as ‘60 GHz communications’. However, in order to transmit, receive, and/or process signals with such high frequencies as 60 GHz, new methods and systems for signal generation are necessary. In this regard, conventional methods of signal generation, such as integer-N and Fractional-N phase locked loops may be difficult or costly to implement as frequencies increase.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for injection locking an oscillator via frequency multiplication of a multi-phase signal, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram illustrating an exemplary LOGEN comprising an oscillator which may be injection locked utilizing a selectable phase shift, in accordance with an embodiment of the invention.

FIG. 2a is a diagram illustrating an exemplary frequency multiplication circuit, in accordance with an embodiment of the invention.

FIG. 2b is a diagram illustrating frequency multiplication of a multiphase signal, in accordance with an embodiment of the invention.

FIG. 3 is a flow chart illustrating exemplary steps for injection locking an oscillator via frequency multiplication of a multi-phase signal, in accordance with an embodiment of the invention.

FIG. 4 is a diagram of a transceiver, in accordance with an embodiment of the invention.

FIG. 5 is a block diagram illustrating an exemplary RF communication device, in accordance with an embodiment of the invention.

### DETAILED DESCRIPTION OF THE INVENTION

Certain embodiments of the invention may be found in a method and system for injection locking an oscillator via frequency multiplication of a multi-phase signal, are provided. In this regard, a plurality of signals, each of which may be a phase shifted version of a reference signal, may be generated and utilized to generate an output signal. The output signal may be utilized to control a frequency of an oscillator. The frequency of the output signal may be a multiple of the reference frequency, and may be equal to the number of said first signals comprising said plurality. The frequency of the reference signal may be determined based on the number of said first signals comprising said plurality and on a desired frequency of the output signal. The number of signals comprising the plurality of first signals may be determined based on a frequency of said reference signal and on a desired frequency of said output signal.

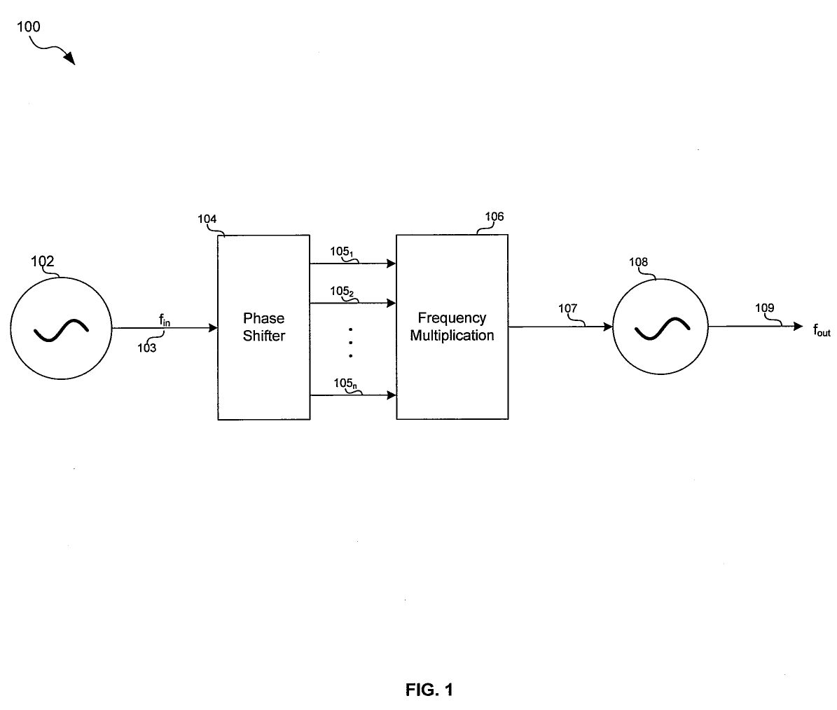

FIG. 1 is a block diagram illustrating an exemplary local oscillator generator (LOGEN) comprising an oscillator which may be injection locked utilizing a selectable phase shift, in accordance with an embodiment of the invention. Referring to FIG. 1 there is shown a LOGEN 100 which may comprise a reference oscillator 102, a phase shifter 104, a frequency multiplication block 106, and an output oscillator 108.

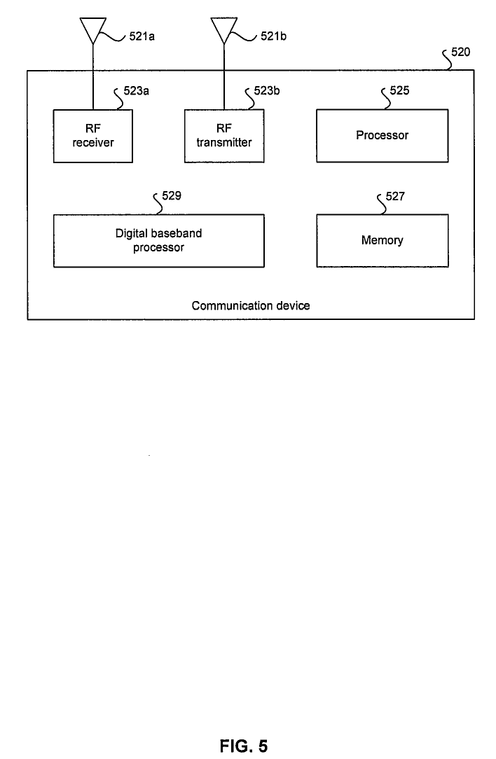

The reference oscillator 102 may comprise suitable logic, circuitry and/or code for generating a reference frequency. In this regard, the signal 103 output by the reference oscillator 102 may be stable with regards to jitter, phase noise, frequency, amplitude, and/or other characteristics. The reference oscillator 102 may, for example, comprise one or more crystal oscillators and/or PLL circuits. In this regard, the frequency of the reference oscillator may be configurable. Accordingly, the reference oscillator 102 may receive one or more control signals from a processor, such as the processor 525 of FIG. 5.

In another embodiment of the invention, the reference oscillator 102 may inherently generate multiple phases of the signal 103. For example, an ‘n’ stage ring oscillator may inherently generate ‘n’ phases of the signal 103.

The phase shifter 102 may comprise suitable logic circuitry and or code that may enable generating ‘n’ phase shifted versions of the signal 103. In this regard, each of the signals 105ᵢ (for 1≦i≦n) output by the phase shifter 102 may be phase shifted by an amount Φᵢ relative to the signal 103. Additionally, in various embodiments of the invention, in order to maintain a 50% duty cycle for the output signal, the phase difference between Φ_{I and} Φᵢ₊₁ may be equal to 180°/n. In various embodiments of the invention, the phase shifter 102 may be configurable to control how many phases are generated. In this regard, the phase shifter 102 may receive one or more control signals from a processor, such as the processor 525 in FIG. 5.

In other embodiments of the invention, such as the case where the reference oscillator comprises an ‘n’ stage ring oscillator, the phase shifter 102 may be unnecessary. In this regard, the output of a ring oscillator, for example, may be coupled to the frequency multiplication block 106.

The frequency multiplication block 106 may comprise suitable logic, circuitry, and/or code that may enable combining the signals 103₁, . . . , 103ₙ to generate a signal 107 which has frequency that is ‘n’ times the frequency of the signals 103. In various embodiments of the invention, the frequency multiplication block 106 may be configurable based on the value of ‘n’. In this regard, the frequency multiplication block 106 may receive one or more control signals from, for example,

The output oscillator 108 may comprise suitable logic, circuitry, and/or code that may enable locking to a frequency of the signal 107. In this regard, with no signal 107 (or a weak signal 107), the output oscillator 108 may oscillate at a first frequency. However, when a sufficiently strong signal 107, oscillating at a second frequency, is injected to the output oscillator 108, the output oscillator 108 may be “pulled” to the first frequency. When the output oscillator 108 oscillates at the frequency of the signal 107, the output oscillator may be said to be “injection locked” to the signal 107. In this regard, injection locking may provide the advantage that a relatively weak signal 107 may be enabled to control a frequency of a strong signal 109.

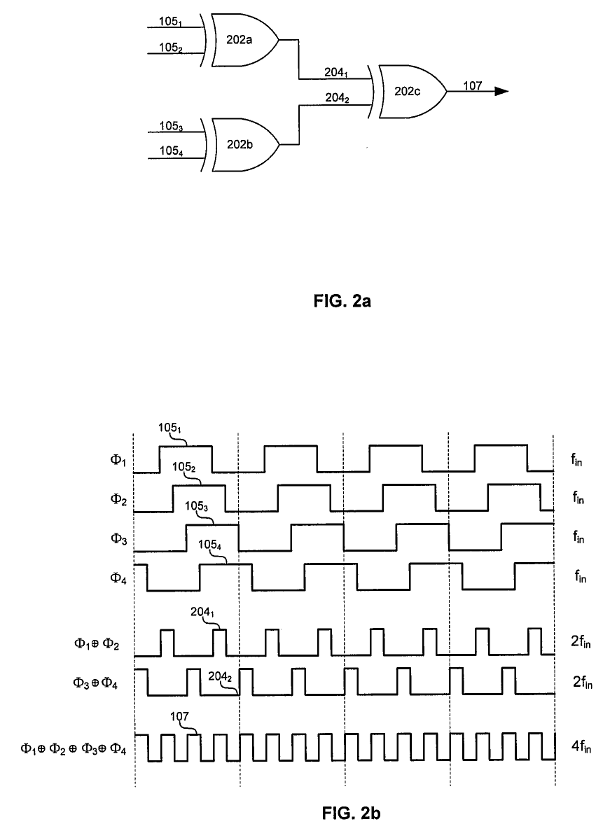

FIG. 2a is a diagram illustrating an exemplary frequency multiplication block, in accordance with an embodiment of the invention. Referring to FIG. 2a, the frequency multiplication block 106 may comprise a plurality of exclusive-or (XOR) gates 202. Accordingly, the frequency multiplication block 106 may comprise high speed combinational logic, which may be capable of generating extremely high frequency signals.

Each of the XOR gates 202 may comprise suitable logic, circuitry, and/or code that may enable performing an exclusive or function as defined by the following table:

TABLE 1
XOR function

| In1 | In2 | Out |
|---|---|---|
| 0 | 0 | 0 |
| 0 | 1 | 1 |
| 1 | 0 | 1 |
| 1 | 1 | 1 |

where ‘In1’ and “In2” are the two inputs to each gate and “out” is the output of the gate.

In the exemplary embodiment of the invention depicted in FIG. 2a, the value of ‘n’ may be equal to 4. Each gate 202 may receive two signals and output the result of performing an exclusive-or operation on the two inputs. In this manner, the circuit of FIG. 2a may perform the function of EQ. 1 below.

107=105₁⊕105₂⊕105₃⊕105₄ EQ. 1

With reference to FIG. 2b, EQ. 1 has the effect of multiplying the frequency of the input signal, 105, by ‘n’. Accordingly, in the exemplary embodiment of the invention depicted, the frequency of signal 107 may be 4 times the frequency of the signal 105. This may be generalized to ‘n’ phases as shown in EQ. 2,

f₁₀₇=n·f₁₀₅ EQ. 2

where f₁₀₇ is the frequency of the signal 107 and f₁₀₅ is the frequency of the signal 105 and ‘n’ is the number of phases of the signal 105.

FIG. 2b is a diagram illustrating frequency multiplication of a multiphase signal, in accordance with an embodiment of the invention. Referring to FIG. 2b, there is shown exemplary waveforms for the signals 105₁, . . . , 105ₙ, the signals 204₁, 204₂, and the signal 107.

In the exemplary embodiment of the invention depicted in FIG. 2b, the four signals 105₁, 105₂, 105₃, and 105₄ (with respective phases Φ₁, Φ₂, Φ₃, and Φ₄) may be utilized to generate a signal 107 that is four times the frequency of the signals 105₁, . . . , 105₄.

The signal 204₁ may be the result of 105₁ XOR 105₂. In this regard, the signal 204₁ may be high when either of the signals 105₁ or 105₂ is high, the signal 204₁ may be low when both of the signals 105₁ and 105₂ are high, and the signal 204₁ may be low when both of the signals 105₁ and 105₂ are low.

The signal 204₂ may be the result of 105₃ XOR 105₄. In this regard, the signal 204₂ may be high when either of the signals 105₃ or 105₄ is high, the signal 204₂ may be low when both of the signals 105₃ and 105₃ are high, and the signal 204₂ may be low when both of the signals 105₃ and 105₄ are low.

The signal 107 may be the result of 204₁ XOR 204₂, which may be equal to EQ. 1 above. In this regard, the signal 107 may be high when either of the signals 204₁ or 204₂ is high, the signal 107 may be low when both of the signals 204₁ or 204₂ are high, and the signal 107 may be low when both of the signals 204₁ or 204₂ are low.

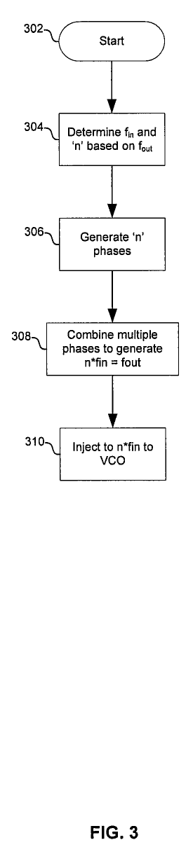

FIG. 3 is a flow chart illustrating exemplary steps for injection locking an oscillator utilizing a selectable phase shift, in accordance with an embodiment of the invention. Referring to FIG. 3, the exemplary steps may begin with start step 302. Subsequent to start step 302, the exemplary steps may advance to step 304. In step 304, a frequency, fᵢₙ, of the reference signal 103, and a number of phases ‘n’ of the signals 105₁, . . . , 105ₙ may be determined based on a desired frequency, fₒᵤₜ, of the signal 107. In this regard, fₒᵤₜ may be determined by the EQ. 2 above. Accordingly, the reference oscillator 102, which may comprise a PLL, may be adjusted to output the determined fᵢₙ. Subsequent to start step 304, the exemplary steps may advance to step 306. In step 306, the frequency multiplication block 106 may generate the signals 105₁, . . . , 105ₙ. Subsequent to start step 306, the exemplary steps may advance to step 308. In step 308, the signals 105₁, . . . , 105ₙ may be utilized to generate the signal 107 which may be ‘n’ times the frequency of the signals 105₁, . . . , 105ₙ. Subsequent to step 308, the exemplary steps may advance to step 310. In step 310, the frequency generated in step 308 may be injected into the output oscillator 108. In this manner, the output oscillator 108 may be “locked” to n*fᵢₙ. Accordingly, aspects of the invention may enable controlling an output oscillator utilizing a reference oscillator which is significantly lower in frequency. For example, in the embodiment depicted in FIGS. 2a and 2b, a 60 GHz output signal may be controlled utilizing a 15 GHz reference signal.

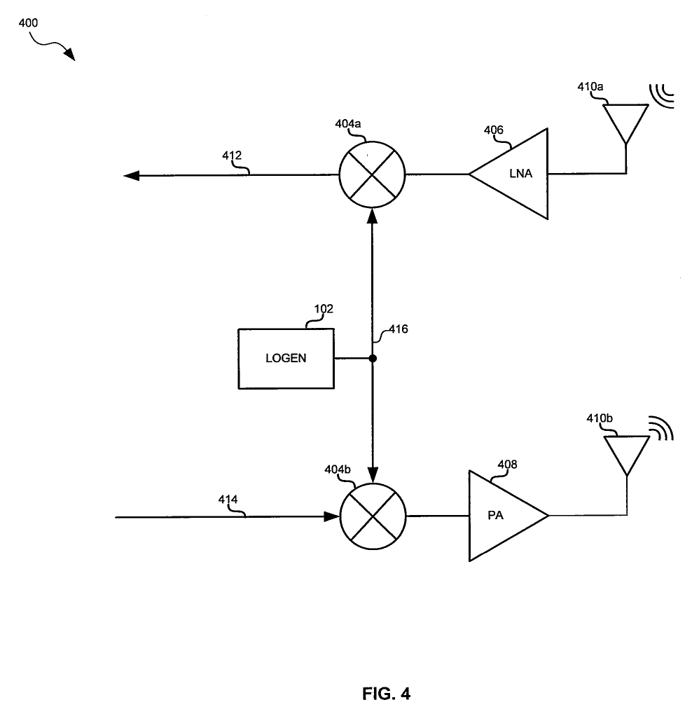

FIG. 4 is a diagram of a transceiver, in accordance with an embodiment of the invention. Referring to FIG. 4 there is shown a transceiver 400 which may be all or a portion of the RF receiver 523a, for example. The transceiver 400 may comprise local oscillator generator (LOGEN) 100, mixers 404a and 404b, a low noise amplifier (LNA) 406, a power amplifier 408, antennas 410a and 410b, and PA calibration block 412.

The LOGEN 100 may comprise suitable logic, circuitry, and/or code that may enable generating a reference signal. In this regard, the LOGEN 100 may comprise a phase locked loop (PLL) which may have a direct digital frequency synthesizer (DDFS) in a feedback path. In an exemplary embodiment, of the invention, the transceiver 400 may directly convert between RF and baseband. Accordingly, the frequency of the signal 416, F_{LO}, may be (F_{RF}±F_{baseband}).

The mixer 404a may comprise suitable logic, circuitry, and/or code that may enable generation of inter-modulation products resulting from mixing the output of the LNA 406 and the LO signal 416. Similarly, the mixer 404b may comprise suitable logic, circuitry, and/or code that may enable generation of inter-modulation products resulting from mixing the baseband signal 414 and the LO signal 416. In various embodiments of the invention the output of the mixers may be filtered such that desired inter-modulation products are passed with less attenuation than undesired inter-modulation products.

The LNA 406 may comprise suitable logic, circuitry, and/or code that may enable buffering and/or amplification of received RF signals. In this regard, the gain of the LNA 406 may be adjustable to enable reception of signals of varying strength. Accordingly, the LNA 406 may receive one or more control signals from a processor such as the processors 525 and 529 of FIG. 5.

The PA 408 may comprise suitable logic, circuitry, and/or code that may enable buffering and/or amplification of a RF signal and outputting the signal to an antenna for transmission. In this regard, the gain of the PA 408 may be adjustable and may enable transmitting signals of varying strength. Accordingly, the PA 408 may receive one or more control signals from a processor such as the processors 525 and 529 of FIG. 5.

The antennas 410a and 410b may comprise suitable logic, circuitry, and/or code that may enable reception and/or transmission of signals of up to EHF. In various embodiments of the invention there may be separate transmit and receive antennas, as depicted, or there may be a single antenna for both transmit and receive functions.

In an exemplary receive operation, RF signals may be received by the antenna 410a and may be conveyed to the LNA 406. The LNA 406 may amplify the received signal and convey it to the mixer 404a. In this regard, the gain of the LNA may be adjusted based on received signal strength. Additionally, the gain may be controlled via one or more control signals from, for example, a processor such as the processors 525 and 529 of FIG. 5. The LO signal 416 may be coupled to the mixer 404a such that the received signal of frequency F_{RF} may be down-converted to a baseband signal 412. The baseband signal 412 may be conveyed, for example, to a baseband processor such as the baseband processor 529 of FIG. 5.

In an exemplary transmit operation, a baseband signal 414 may be conveyed to the mixer 404b. The LO signal 416 may be coupled to the mixer 404b and the baseband signal 414, of frequency F_{baseband}, may be up-converted to RF. The RF signal may be conveyed to the PA 408 for transmission via the antenna 410b. In this regard, the gain of the PA 408 may be adjusted via one or more control signals from, for example, a processor such as the processors 525 and 529 of FIG. 5.

FIG. 5 is a block diagram illustrating an exemplary RF communication device, in accordance with an embodiment of the invention. Referring to FIG. 5, there is shown a RF communication device 520 that may comprise an RF receiver 523a, an RF transmitter 523b, a digital baseband processor 529, a processor 525, and a memory 527. A receive antenna 521a may be communicatively coupled to the RF receiver 523a. A transmit antenna 521b may be communicatively coupled to the RF transmitter 523b. The RF communication device 520 may be operated in a system, such as the cellular network and/or digital video broadcast network, for example.

The RF receiver 523a may comprise suitable logic, circuitry, and/or code that may enable processing of received RF signals. In this regard, the receiver may be enabled to generate signals, such as local oscillator signals, for the reception and processing of RF signals. The RF receiver 523a may down-convert received RF signals to a baseband frequency signal. The RF receiver 523a may perform direct down-conversion of the received RF signal to a baseband frequency signal, for example. In some instances, the RF receiver 523a may enable analog-to-digital conversion of the baseband signal components before transferring the components to the digital baseband processor 529. In other instances, the RF receiver 523a may transfer the baseband signal components in analog form.

The digital baseband processor 529 may comprise suitable logic, circuitry, and/or code that may enable processing and/or handling of baseband frequency signals. In this regard, the digital baseband processor 529 may process or handle signals received from the RF receiver 523a and/or signals to be transferred to the RF transmitter 523b. The digital baseband processor 529 may also provide control and/or feedback information to the RF receiver 523a and to the RF transmitter 523b based on information from the processed signals. In this regard, the baseband processor 529 may provide a control signal to one or more of the oscillator 102, the phase shifter 104, the frequency multiplication block 106, and/or the oscillator 108. The digital baseband processor 529 may communicate information and/or data from the processed signals to the processor 525 and/or to the memory 527. Moreover, the digital baseband processor 529 may receive information from the processor 525 and/or to the memory 527, which may be processed and transferred to the RF transmitter 523b for transmission to the network.

The RF transmitter 523b may comprise suitable logic, circuitry, and/or code that may enable processing of RF signals for transmission. In this regard, the transmitter may be enabled to generate signals, such as local oscillator signals, for the transmission and processing of EHF signals. The RF transmitter 523b may up-convert the baseband frequency signal to an RF signal. The RF transmitter 523b may perform direct up-conversion of the baseband frequency signal to a RF signal of approximately 60 GHz, for example. In some instances, the RF transmitter 523b may enable digital-to-analog conversion of the baseband signal components received from the digital baseband processor 529 before up conversion. In other instances, the RF transmitter 523b may receive baseband signal components in analog form.

The processor 525 may comprise suitable logic, circuitry, and/or code that may enable control and/or data processing operations for the RF communication device 520. The processor 525 may be utilized to control at least a portion of the RF receiver 523a, the RF transmitter 523b, the digital baseband processor 529, and/or the memory 527. In this regard, the processor 525 may generate at least one signal for controlling operations within the RF communication device 520. In this regard, the processor 525 may provide a control signal to one or more of the oscillator 102, the phase shifter 104, the frequency multiplication block 106, and/or the oscillator 108. The processor 525 may also enable executing of applications that may be utilized by the RF communication device 520. For example, the processor 525 may execute applications that may enable displaying and/or interacting with content received via RF signals in the RF communication device 520.

The memory 527 may comprise suitable logic, circuitry, and/or code that may enable storage of data and/or other information utilized by the RF communication device 520. For example, the memory 527 may be utilized for storing processed data generated by the digital baseband processor 529 and/or the processor 525. The memory 527 may also be utilized to store information, such as configuration information, that may be utilized to control the operation of at least one block in the RF communication device 520. For example, the memory 527 may comprise information necessary to configure the RF receiver 523a to enable receiving signals in the appropriate frequency band. In this regard, the memory 527 may store control and/or configuration information for one or more of the oscillator 102, the phase shifter 104, the frequency multiplication block 106, and/or the oscillator 108.

Aspects of a method and system for injection locking an oscillator via frequency multiplication of a multi-phase signal are provided. A plurality of signals 105₁, . . . , 105ₙ, each of which may be a phase shifted version of a reference signal 103, may be generated and utilized to generate an output signal 107. The output signal 107 may be utilized to control a frequency of an oscillator 108. The frequency of the output signal 107 may be a multiple of the reference frequency 103, and may be equal to the number, n, of said first signals 105₁, . . . , 105ₙ. The frequency of the reference signal may be determined based on the number, n, of said first signals and on a desired frequency of the output signal 107. The number of signals, n, comprising the plurality of first signals may be determined based on a frequency of said reference signal 103 and on a desired frequency of said output signal 107.

Another embodiment of the invention may provide a machine-readable storage, having stored thereon, a computer program having at least one code section executable by a machine, thereby causing the machine to perform the steps as described herein for injection locking an oscillator via frequency multiplication of a multi-phase signal.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for signal processing, the method comprising:
generating a plurality of first signals, each of which is a phase shifted version of a reference signal;
generating an output signal utilizing said plurality of first signals, wherein a frequency of said output signal is a multiple of a frequency of said reference signal; and
controlling a frequency of an oscillator utilizing said generated output signal.

2. The method according to claim 1, comprising generating said output signal via a plurality of exclusive-or gates.

3. The method according to claim 1, comprising programmatically controlling a frequency of said reference signal.

4. The method according to claim 1, comprising determining a frequency of said reference signal based on an available number of phases of said plurality of first signals and based on a desired frequency of said output signal.

5. The method according to claim 1, comprising programmatically controlling at least a portion of said generated plurality of first signals.

6. The method according to claim 1, comprising determining a number of said first signals based on a frequency of said reference signal and based on a desired frequency of said output signal.

7. The method according to claim 1, wherein said multiple of said frequency of said reference signal is equal to an available number of phases of said plurality of first signals.

8. A machine-readable storage having stored thereon, a computer program having at least one code section for signal processing, the at least one code section being executable by a machine for causing the machine to perform steps comprising:
generating a plurality of first signals, each of which is a phase shifted version of a reference signal;
generating an output signal utilizing said plurality of first signals, wherein a frequency of said output signal is a multiple of a frequency of said reference signal; and
controlling a frequency of an oscillator utilizing said generated output signal.

9. The machine-readable storage according to claim 7, wherein said at least one code section enables generating said output signal via a plurality of exclusive-or gates.

10. The machine-readable storage according to claim 7, wherein said at least one code section enables programmatically controlling a frequency of said reference signal.

11. The machine-readable storage according to claim 7, wherein said at least one code section enables determining a frequency of said reference signal based on an available number of phases of said plurality of first signals and based on a desired frequency of said output signal.

12. The machine-readable storage according to claim 7, wherein said at least one code section enables programmatically controlling at least a portion of said generated plurality of first signals.

13. The machine-readable storage according to claim 7, wherein said at least one code section enables determining a number of said first signals based on a frequency of said reference signal and based on a desired frequency of said output signal.

14. The machine-readable storage according to claim 7, wherein said multiple of said frequency of said reference signal is equal to an available number of phases of said plurality of first signals.

15. A system for signal processing, the system comprising:
one or more circuits that:
generate a plurality of first signals, each of which is a phase shifted version of a reference signal;
generate an output signal utilizing said plurality of first signals, wherein a frequency of said output signal is a multiple of a frequency of said reference signal; and
control a frequency of an oscillator utilizing said generated output signal.

16. The system according to claim 15, wherein said one or more circuits generate said output signal via a plurality of exclusive-or gates.

17. The system according to claim 15, wherein said one or more circuits programmatically control a frequency of said reference signal.

18. The system according to claim 15, wherein said one or more circuits determine a frequency of said reference signal based on an available number of phases of said plurality of first signals and based on a desired frequency of said output signal.

19. The system according to claim 15, wherein said one or more circuits programmatically controlling at least a portion of said generated plurality of first signals.

20. The system according to claim 15, wherein said one or more circuits determine a number of said first signals based on a frequency of said reference signal and based on a desired frequency of said output signal.

21. The system according to claim 15, wherein said multiple of said frequency of said reference signal is equal to an available number of phases of said plurality of first signals.
